(19) United States
(12) Patent Application Publication
(10) Pub. No.: US 2019/0187495 A1
(43) Pub. Date: Jun. 20, 2019

(54) OPTICAL MODULATOR AND A DRIVING CIRCUIT THEREFOR

(71) Applicant: Nokia Solutions and Networks OY, Espoo (FI)

(72) Inventors: Argishti Melikyan, Matawan, NJ (US); Po Dong, Morganville, NJ (US)

(73) Assignee: Nokia Solutions and Networks OY, Espoo (FI)

(21) Appl. No.: 15/845,073

(22) Filed: Dec. 18, 2017

(51) Int. Cl. G02F 1/035; G02F 1/03; G02F 1/017; G02F 1/01

(52) U.S. Cl. CPC G02F 1/0353; G02F 1/0327; G02F 2001/212; G02F 1/0123; G02F 2201/127; G02F 1/01708

(57) ABSTRACT

An electro-optical circuit in which diode-like electrical characteristics of an optical modulator employed therein are used to generate one or more DC-offset levels that place the optical modulator into a proper electrical operating configuration for modulating light transmitted therethrough. In an example embodiment, the optical modulator includes an optical waveguide comprising at least a portion of a semiconductor diode connected to a data driver using a clamping circuit, the clamping circuit being configured to cause a data-modulated electrical signal outputted by the data driver to set a DC-offset level applied to the semiconductor diode. As a result, the use of on-chip and/or on-board bias-tees can advantageously be avoided. In some embodiments, the optical modulator can be driven using two different data signals, each used to set a different respective DC-offset level at the semiconductor diode. In various embodiments, the optical modulator can be an intensity modulator and/or a phase modulator.

### BACKGROUND

### Field

The present disclosure relates to optical communication equipment and, more specifically but not exclusively, to optical modulators and driving circuits therefor.

### Description of the Related Art

This section introduces aspects that may help facilitate a better understanding of the disclosure. Accordingly, the statements of this section are to be read in this light and are not to be understood as admissions about what is in the prior art or what is not in the prior art.

An optical modulator is a device that can be used to manipulate a property of light, e.g., of an optical beam. Depending on which property of the optical beam is controlled, the optical modulator can be referred to as an intensity modulator, a phase modulator, a polarization modulator, a spatial-mode modulator, etc. A wide range of optical modulators is used, e.g., in the telecom industry.

### SUMMARY OF SOME SPECIFIC EMBODIMENTS

Disclosed herein are various embodiments of an electro-optical circuit in which diode-like electrical characteristics of an optical modulator employed therein are used to generate one or more DC-offset levels that place the optical modulator into a proper electrical operating configuration for modulating light transmitted therethrough. In an example embodiment, the optical modulator includes an optical waveguide comprising at least a portion of a semiconductor diode connected to a data driver using a clamping circuit, the clamping circuit being configured to cause a data-modulated electrical signal outputted by the data driver to set a DC-offset level applied to the semiconductor diode. As a result, the use of on-chip and/or on-board bias-tees can advantageously be avoided. In some embodiments, the optical modulator can be driven using two different data signals, each used to set a different respective DC-offset level at the semiconductor diode. In various embodiments, the optical modulator can be an intensity modulator and/or a phase modulator.

According to one embodiment, provided is an apparatus comprising: an optical modulator comprising an optical waveguide that includes at least a portion of a semiconductor diode, the semiconductor diode being electrically connected between first and second electrical terminals, the optical waveguide being optically coupled between an optical input and an optical output of the optical modulator; and a data driver connected to the first and second electrical terminals to electrically drive the optical modulator in a manner that causes the optical modulator to modulate light traveling from the optical input to the optical output thereof in response to an input data signal received by the data driver; and wherein the data driver is electrically connected to the first and second electrical terminals in a manner that causes a first varying electrical signal generated by the data driver in response to the input data signal to set a first DC-offset level at one of the first and second electrical terminals of the semiconductor diode, the first DC-offset level being such as to cause the semiconductor diode to be reverse-biased.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 shows a block diagram of an electro-optical circuit according to an embodiment;

FIGS. 2A-2B show schematic diagrams of an optical modulator that can be used in the electro-optical circuit of FIG. 1 according to an embodiment;

FIGS. 3A-3B show schematic diagrams of an optical modulator that can be used in the electro-optical circuit of FIG. 1 according to another embodiment;

FIG. 4 shows a circuit diagram of an electro-optical circuit that can be used to implement the electro-optical circuit of FIG. 1 according to an embodiment;

FIG. 5 graphically shows example electrical signals in the electro-optical circuit of FIG. 4 according to an embodiment;

FIG. 6 shows a block diagram of an electro-optical circuit according to an alternative embodiment; and

FIG. 7 shows a circuit diagram of an electro-optical circuit that can be used to implement the electro-optical circuit of FIG. 6 according to an embodiment.

### DETAILED DESCRIPTION

Electrical properties of some semiconductor-based optical modulators are similar to those of an electrical diode. In operation, some of such optical modulators require a forward or reverse electrical bias to place the modulator into a proper electrical operating configuration. This requirement can turn the design of the corresponding driver chip, circuit, and/or printed circuit board into a rather challenging proposition, e.g., because an appropriate (positive or negative) DC offset needs to be added to the varying electrical signal representing the data that are to be carried by the modulated optical beam outputted by the optical modulator.

One approach to solving this problem includes the use of a bias-tee connected to the output of an AC-coupled data driver. Designing an on-chip bias-tee for relatively high (e.g., ≥25 Gb/s) data rates can be difficult, e.g., because large inductances may be needed to implement the bias-tee. The latter problem might be further complicated when the optical modulator needs to be driven by two or more different varying electrical signals. An example of the optical modulator of this type is a differentially driven modulator, wherein the SIGNAL and SIGNAL_BAR (inverted signal) lines may require different DC offsets.

At least some of these and other related problems in the state of the art are addressed by different embodiments disclosed herein according to which inherent diode-like electrical characteristics of certain semiconductor-based optical modulators are used to generate a DC offset level that places the modulator into a proper electrical operating configuration. As a result, the use of on-chip and/or on-board bias-tees can advantageously be avoided. The disclosed approach can beneficially be implemented for different types of optical modulators, e.g., intensity and/or phase modulators. Some non-limiting examples of such optical modulators include a microring modulator, an electro-absorption modulator, a Mach-Zehnder modulator, and an IQ modulator, each of which can be implemented using a variety of suitable semiconductor materials known to those skilled in the pertinent art.

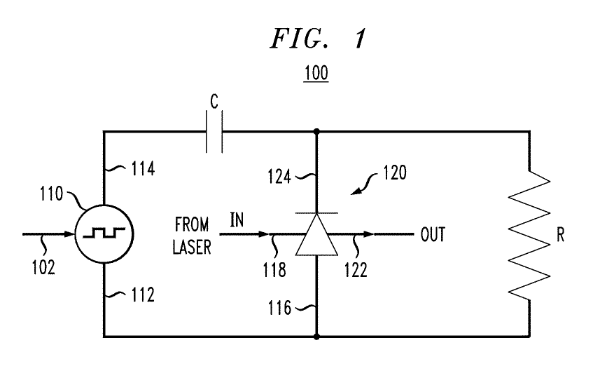

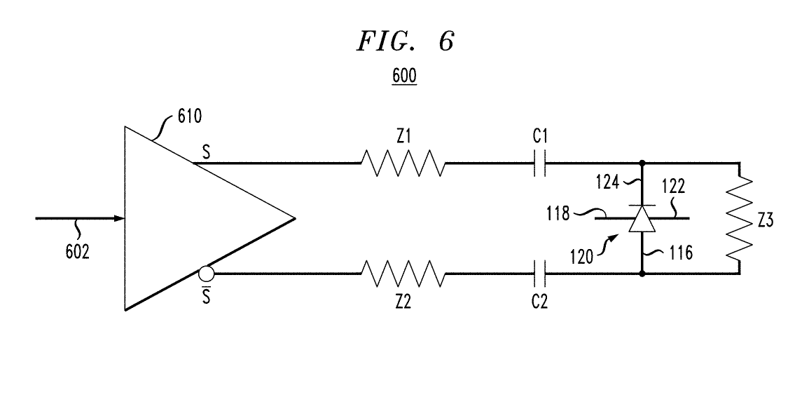

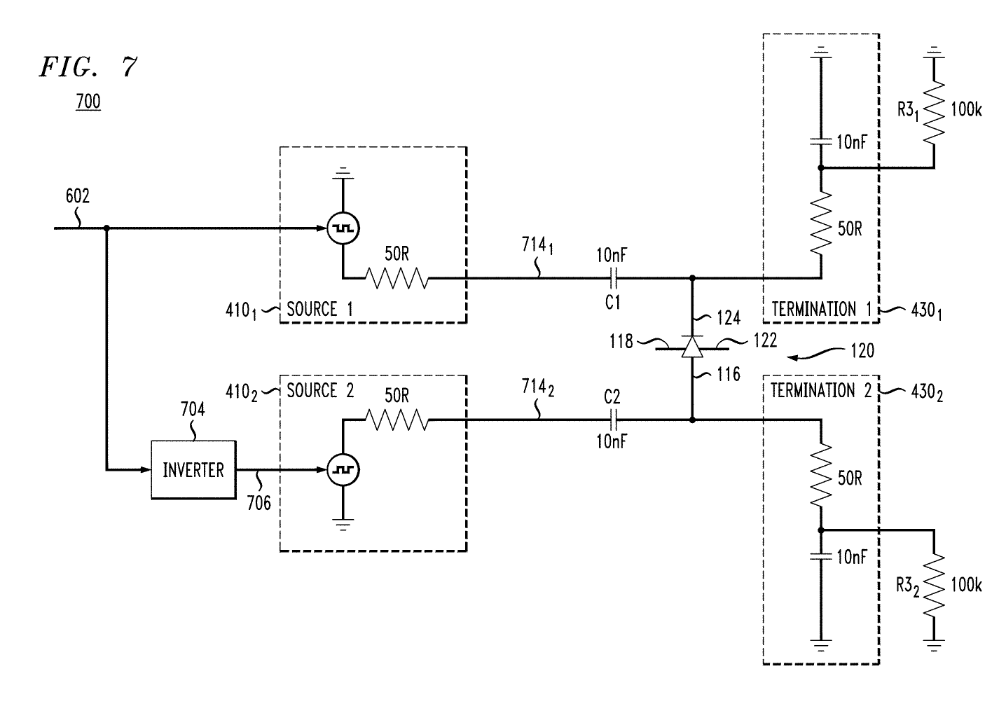

FIG. 1 shows a block diagram of an electro-optical circuit 100 according to an embodiment. Circuit 100 comprises a waveform generator 110 and an optical modulator 120 connected to one another using a capacitor C and a resistor R such as to form a positive clamping circuit. A person of ordinary skill in the art will understand that, in an alternative embodiment, waveform generator 110 and optical modulator 120 can be similarly connected using a negative clamping circuit (e.g., see FIGS. 6-7).

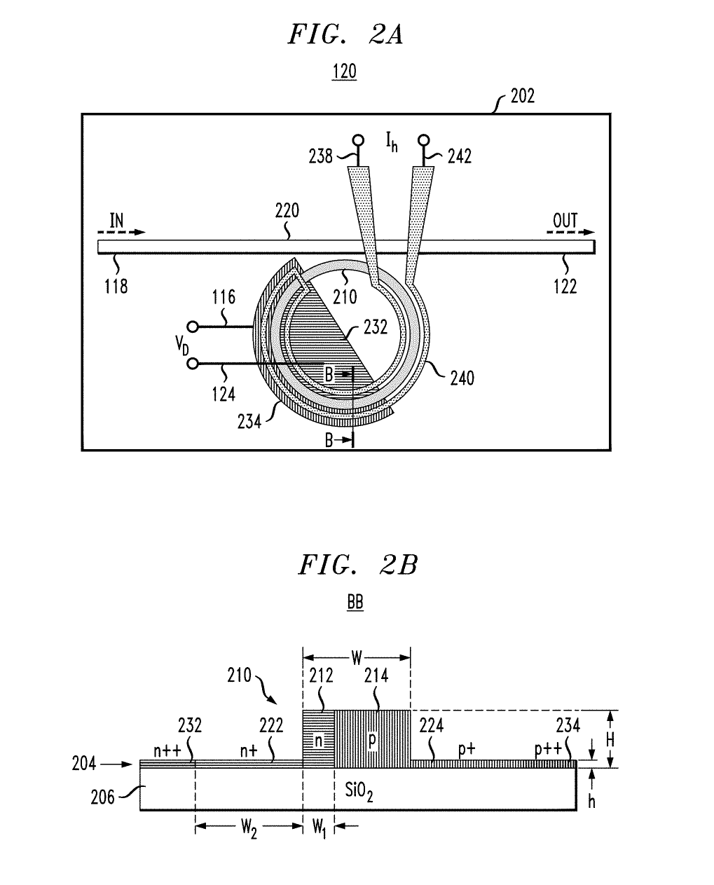

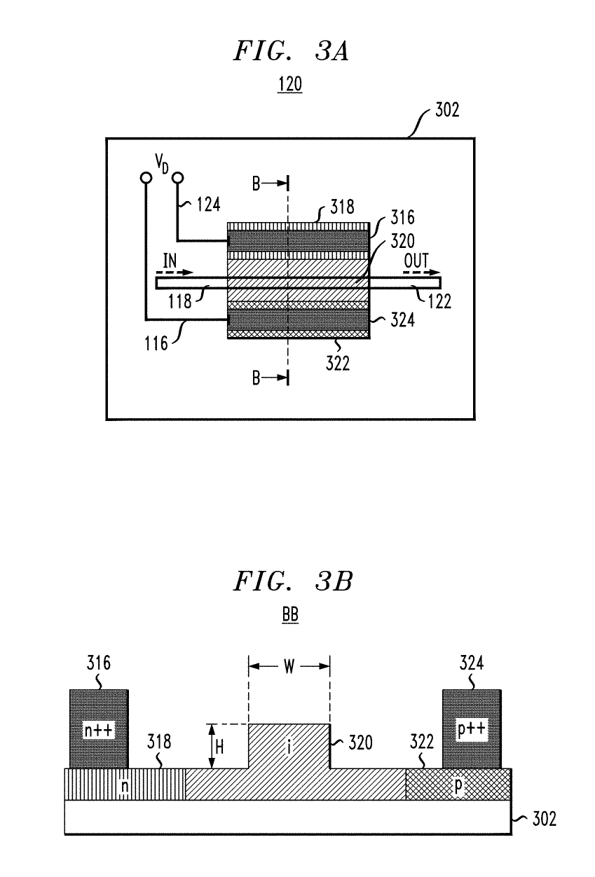

Optical modulator 120 comprises an input optical waveguide 118 and an output optical waveguide 122. Input optical waveguide 118 is connected to receive light from a suitable light source (e.g., a semiconductor laser). In operation, optical modulator 120 modulates the received light in response to an electrical drive signal applied to electrical terminals 116 and 124 thereof and outputs the resulting modulated optical beam through output optical waveguide 122. Electrical response of optical modulator 120 to an electrical signal applied to electrical terminals 116 and 124 may be similar to that of an electrical diode. The latter characteristic of optical modulator 120 is indicated in FIG. 1 by depicting that optical modulator using the conventional diode symbol. Example semiconductor devices that can cause optical modulator 120 to behave similar to an electrical diode are shown and described in more detail below in reference to FIGS. 2-3.

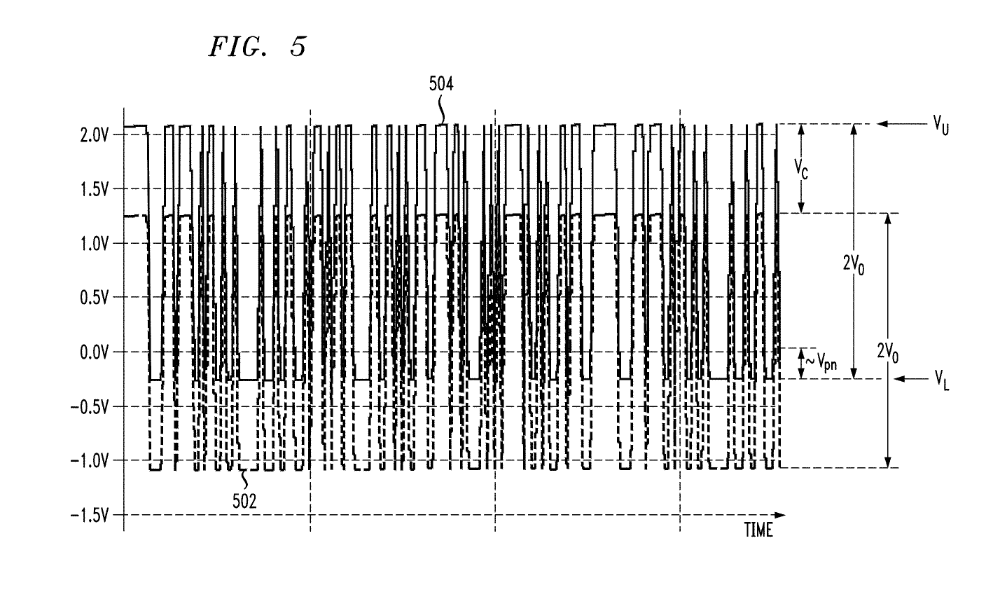

In an example embodiment, generator 110 operates as a data driver that generates a varying output voltage V_{OUT} between electrical output terminals 112 and 114 thereof in response to an input data signal 102. Output voltage V_{OUT} oscillates around the zero (e.g., ground) level and has a peak-to-peak swing of 2V₀. An example waveform representing output voltage V_{OUT} is shown and described in more detail below in reference to FIG. 5.

In the embodiment of FIG. 1, capacitor C, resistor R, and an electrical-diode structure of optical modulator 120 act together to add a positive offset voltage V_{C} to output voltage V_{OUT}, thereby causing the drive voltage V_{D} between electrical terminals 116 and 124 to be approximately described by Eq. (1) as follows:

V_{D}=V_{OUT}+V_{C} (1)

More specifically, during the negative swing of output voltage V_{OUT}, the electrical-diode structure of optical modulator 120 is forward-biased and conducts, thereby charging capacitor C to the peak negative value of V_{OUT}. During the positive swing of output voltage V_{OUT}, the electrical-diode structure of optical modulator 120 is reverse-biased and thus substantially does not conduct. The voltage across the electrical-diode structure of optical modulator 120 is therefore equal to the sum of output voltage V_{OUT} and the voltage across capacitor C. If capacitor C is not initially charged, then some transitory time is needed to reach a steady state. The capacitance of capacitor C and the resistance of resistor R determine the range of frequencies over which the clamping circuit formed by capacitor C, resistor R, and optical modulator 120 is effective.

As used herein, the term “reverse bias” refers to an electrical configuration of a semiconductor-junction diode in which the N-type material is at a high electrical potential, and the P-type material is at a low electrical potential. The reverse bias typically causes the depletion layer to grow wider due to a lack of electrons and/or holes, which presents a high impedance path across the junction and substantially prevents a current flow therethrough. However, a very small reverse leakage current can still flow through the junction.

Similarly, the term “forward bias” refers to an electrical configuration of a semiconductor-junction diode in which the N-type material is at a low potential, and the P-type material is at a high potential. If the forward bias is greater than the intrinsic voltage drop Vₚᵤ across the corresponding PN or PIN junction, then the corresponding potential barrier can be overcome by the electrical carriers, and a relatively large forward current can flow through the junction. For example, for silicon-based diodes the value of Vₚₙ is approximately 0.7 V. For germanium-based diodes, the value of Vₚₙ is approximately 0.3 V, etc.

The selection of V_{C} typically depends on the implementation specifics of optical modulator 120, such as the choice of semiconductor materials used therein, the relative arrangement of variously doped semiconductor regions, etc. As an approximation, the value of V_{C} can be expressed by Eq. (2) as follows:

V_{C}=V₀−Vₚₙ (2)

where Vₚₙ is the voltage drop across the corresponding PN or PIN junction in the electrical-diode structure of optical modulator 120. Based on Eqs. (1) and (2), the upper rail V_{U} and the lower rail V_{L} of the drive voltage V_{D} can be estimated using Eqs. (3)-(4), respectively, as follows:

V_{U}=2V₀−Vₚₙ (3)

V_{L}=−Vₚₙ (4)

In an example embodiment, generator 110 can be configured to generate the output voltage V_{OUT} with the amplitude V₀ selected such that the corresponding offset voltage V_{C} (Eq. (2)) generated in circuit 100 places optical modulator 120 into a proper electrical operating configuration for performing its intended optical function. For example, in the embodiment of FIG. 1, the value of V₀ can be selected such that the corresponding offset voltage V_{C} causes the electrical-diode structure of optical modulator 120 to be under a proper reverse bias. As a result, a bias-tee that is typically used for this purpose in conventional driving circuits is no longer needed and is not present in circuit 100.

In some embodiments, the resistance of resistor R can be selected to be significantly larger than the series resistance of the electrical-diode structure of optical modulator 120.

In some embodiments, the electrical-diode structure of optical modulator 120 can be intentionally designed in a way that causes the reverse leakage current to be relatively large. The latter property can be achieved, e.g., by (i) the inherent device design, (ii) crystal defect creation in the semiconductor materials, (iii) introduction of surface states in some semiconductor layers, etc. In some embodiments, the used semiconductor materials can be selected such that the electrical-diode structure of optical modulator 120 works as a photodiode in response to the light having the intended carrier wavelength. The latter design choice has a similar effect of increasing the effective reverse leakage current under illumination. A person of ordinary skill in the art will understand that the enhanced reverse leakage current implemented in these embodiments may have a beneficial effect of improving the electrical response characteristics of optical modulator 120 and/or the corresponding clamping circuit.

In some embodiments, circuit 100 can be designed such that the leakage current and/or the series resistance of the electrical-diode structure of optical modulator 120 are controlled and defined in a manner that shortens the transitory time leading into the above-mentioned “steady state” and/or increases the offset voltage V_{C}.

In practice, the offset voltage V_{C} may exhibit small variations over time in the steady operating state of circuit 100 due to (i) a small current flowing through the capacitor C during the positive swing of output voltage V_{OUT}, which may cause a relatively small discharge of the capacitor, and (ii) recharging of the capacitor C during the negative swing of output voltage V_{OUT}, which can restore the lost charge. As such, the offset voltage V_{C} can be represented as a sum of a relatively large quasi-DC component and a relatively small varying (time-dependent) component. The prefix “quasi” reflects the fact that the offset voltage V_{C} depends on the amplitude V₀ (e.g., as indicated in Eq. (2)), which itself may fluctuate in time, thereby inducing the corresponding fluctuations of the offset voltage V_{C}. However, such fluctuations of the amplitude V₀ are typically relatively small (e.g., not exceeding ˜5%) for conventional data drivers. Furthermore, known amplitude-stabilization techniques can be used to make such fluctuations of the amplitude V₀ acceptably small, if appropriate or necessary. In addition, such fluctuations of the amplitude V₀ may be relatively slow on the modulation time scale and appear as slow up and down drifts of the amplitude V₀. In any scenario, such fluctuations of the amplitude V₀ do not practically affect the reverse-bias state of the electrical-diode structure of optical modulator 120 and have negligible effect on its optical function.

The effective voltage shift corresponding to the above-described quasi-DC component of the offset voltage V_{C} is referred to herein as the “DC-offset level.”

FIGS. 2A-2B show schematic diagrams of optical modulator 120 according to an embodiment. More specifically, FIG. 2A shows a top view of optical modulator 120. FIG. 2B shows a cross-sectional side view of optical modulator 120 along the planar cross-section BB indicated in FIG. 2A.

The optical modulator 120 shown in FIGS. 2A-2B is a microring modulator implemented using CMOS-compatible processes and materials. In an example embodiment, the optical modulator 120 of FIGS. 2A-2B can be fabricated using a silicon-on-insulator (SOI) substrate 202 and includes a microring waveguide 210 optically coupled to a pass-through linear waveguide 220 as indicated in FIG. 2A. One end of waveguide 220 is configured to operate as input optical waveguide 118 (also see FIG. 1). The other end of waveguide 220 is configured to operate as output optical waveguide 122 (also see FIG. 1). Waveguides 210 and 220 can be formed, e.g., by properly etching down the top silicon layer supported on a silicon-oxide layer 206 of SOI substrate 202 (see FIG. 2B). A silicon-oxide cladding layer (not explicitly shown in FIG. 2B) can then be deposited over the structure shown in FIG. 2B to encapsulate the resulting ridge-waveguide core.

Microring waveguide 210 is a ridge waveguide that has a portion 212 made of n-doped silicon and a portion 214 made of p-doped silicon, the two portions forming a PN junction 212/214 as indicated in FIG. 2B. The location of the PN junction 212/214 may be offset from the center of waveguide 210. In the shown embodiment, the PN junction 212/214 takes up approximately one-half of the microring circumference. In alternative embodiments, the corresponding PN junction may take up more or less than one-half of the microring circumference.

Ohmic contacts between the PN junction 212/214 and electrical terminals 116 and 124 are implemented by varying the dopant concentration within a silicon layer 204 that is adjacent to waveguide 210. More specifically, an n+-doped portion 222 and an n++-doped portion 232 of layer 204 are used to provide an ohmic contact between portion 212 of waveguide 210 and electrical terminal 124. A p+-doped portion 224 and a p++-doped portion 234 of layer 204 are similarly used to provide an ohmic contact between portion 214 of waveguide 210 and electrical terminal 116. Intermediately doped portions 222 and 224 are optional and may not be present in some embodiments.

In some embodiments, an optional thin-film heater 240 may be formed near ring waveguide 210, e.g., as indicated in FIG. 2A. For example, thin-film heater 240 can be implemented using a titanium microstrip that is vertically separated from ring waveguide 210 by a layer of silicon oxide (not explicitly shown in FIGS. 2A-2B). Electrical terminals 238 and 242 can then be used to drive a controllable electrical current Iₕ through thin-film heater 240 to provide a stable thermal environment for the PN junction 212/214 and ring waveguide 210.

In an example embodiment, some elements of the optical modulator 120 shown in FIGS. 2A-2B may have the following dimensions: (i) a 30-μm diameter for microring waveguide 210; (ii) a 0.5-μm width W for microring waveguide 210; (iii) a 0.2-μm width w₁ for portion 212; (iv) a 0.22-μm height H for microring waveguide 210; (v) a 0.05-μm thickness h for layer 204; and (vi) a 0.5-μm width w₂ for portions 222 and 224.

In operation, the PN junction 212/214 functions as a phase shifter. More specifically, when the reverse bias V_{C} is applied to the PN junction 212/214, a depletion region forms within waveguide 210. During the positive swing of output voltage V_{OUT}, the size of this depletion region increases, thereby decreasing the effective refractive index of waveguide 210. During the negative swing of output voltage V_{OUT}, the size of this depletion region decreases, thereby increasing the effective refractive index of waveguide 210. This modulation of the effective refractive index modulates the resonant frequency of the microring accordingly, which changes the transmittance of waveguide 220 at the carrier wavelength, thereby modulating the intensity of the optical beam that travels from input optical waveguide 118 to output optical waveguide 122.

FIGS. 3A-3B show schematic diagrams of optical modulator 120 according to another embodiment. More specifically, FIG. 3A shows a top view of optical modulator 120. FIG. 3B shows a cross-sectional side view of optical modulator 120 along the planar cross-section BB indicated in FIG. 3A.

The optical modulator 120 shown in FIGS. 3A-3B is an electro-absorption modulator. The choice of materials for this particular embodiment of optical modulator 120 depends on the intended operating wavelength. For example, GaAs, InGaAs, and/or AlGaAs may be used for carrier wavelengths in the vicinity of 850 nm. Ge, GeSi, InP, InGaAsP, and/or InGaAlAs may be used for carrier wavelengths in the vicinity of 1310 nm or 1550 nm.

In an example embodiment, the optical modulator 120 of FIGS. 3A-3B can be fabricated on a semiconductor or dielectric substrate 302 and includes a ridge waveguide 320. One end of waveguide 320 is connected to input optical waveguide 118 (also see FIG. 1). The other end of waveguide 320 is connected to output optical waveguide 122 (also see FIG. 1). Ridge waveguide 320 can be made, e.g., of an intrinsically doped Ge, and be sandwiched between, e.g., a layer 318 of n-doped Ge and a layer 322 of p-doped Ge. Waveguide 320 and layers 318 and 322 are arranged to form a lateral PIN diode 318/320/322.

In an example embodiment, ridge waveguide 320 can have a 0.6-μm width W and a 0.35-μm height H.

Ohmic contacts between the PIN diode 318/320/322 and electrical terminals 116 and 124 are implemented using silicon electrodes 316 and 324. More specifically, electrode 316 comprises n++-doped silicon and is connected between layer 318 and electrical terminal 124. Electrode 324 comprises p++-doped silicon and is connected between layer 322 and electrical terminal 116.

The principle of operation of the embodiment of optical modulator 120 shown in FIGS. 3A-3B is based on the Franz-Keldysh effect due to which the optical absorption near the optical band edge of the employed bulk semiconductor material depends on the applied electric field. More specifically, when the reverse bias V_{C} is applied to the PIN diode 318/320/322, waveguide 320 is subjected to an electric field of certain strength. During the positive swing of output voltage V_{OUT}, the electric-field strength increases, thereby red-shifting the band edge. During the negative swing of output voltage V_{OUT}, the electric-field strength decreases, thereby blue-shifting the band edge. These band-edge shifts change the transmittance of waveguide 320 at the carrier wavelength, thereby modulating the intensity of the optical beam that travels from input optical waveguide 118 to output optical waveguide 122.

A person of ordinary skill in the art will understand that, in an alternative embodiment, an electro-absorption modulator 120 can be implemented using a multiple-quantum-well (MQW) structure located within the intrinsically doped portion of the optical waveguide. In this case, the band-edge shifts are primarily caused by the so-called quantum-confined Stark effect (QCSE). Compared to the electro-absorption devices that are based on the Franz-Keldysh effect, the electro-absorption devices that are based on the QCSE are typically able to provide higher depths of modulation, e.g., as quantified by the ON-OFF intensity ratios of the corresponding modulated optical beams. The geometry of the corresponding MQW PIN diode is typically different from that shown in FIGS. 3A-3B in that the PIN (and MQW) layers of the diode are stacked vertically rather than laterally.

Additional embodiments of optical modulator 120 can be implemented using some of the semiconductor devices disclosed, e.g., in U.S. Pat. Nos. 9,690,122, 8,735,868, 7,764,850, 7,672,553, 6,298,177, 6,002,510, and 5,811,838, all of which are incorporated herein by reference in their entirety.

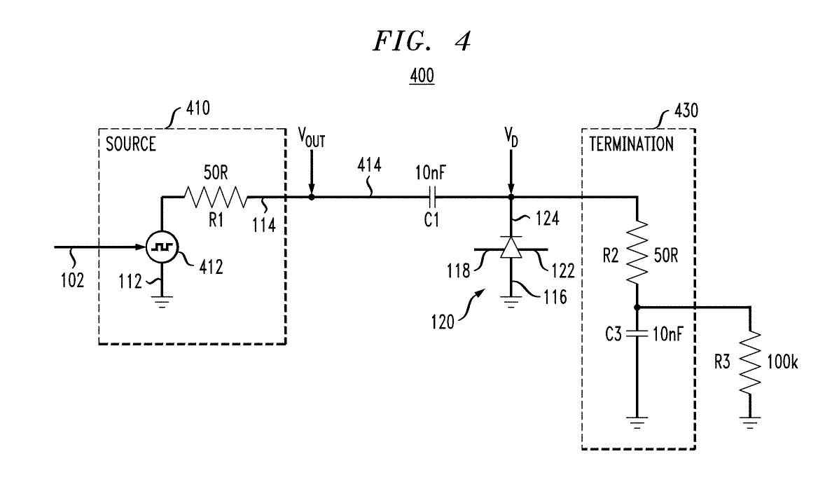

FIG. 4 shows a circuit diagram of an electro-optical circuit 400 that can be used to implement circuit 100 according to an embodiment.

Circuit 400 is designed and configured to have transmission lines that are impedance-matched to 50 ohm. For this purpose, a waveform generator 410 includes a 50-ohm output resistor R1 connected between a data driver 412 and electrical output terminal 114. Similarly, a transmission line 414 that connects electrical terminals 114 and 124 is terminated using a termination circuit 430 that includes a 50-ohm resistor R2.

In circuit 400, a capacitor C1 implements capacitor C (see FIG. 1). A capacitor C3 is used in termination circuit 430 for the AC termination. An optional resistor R3 connected in parallel with capacitor C3 and in series with resistor R2 is used to mitigate possible adverse effects on the impedance matching of any parasitic resistance of the electrical diode structure of optical modulator 120. In some embodiments, resistor R3 may be absent.

FIG. 5 graphically shows example electrical signals in circuit 400 according to an embodiment. More specifically, a waveform 502 represents output voltage V_{OUT} at electrical terminal 114 of generator 410 (FIG. 4) measured with respect to the ground potential. A waveform 504 similarly represents drive voltage V_{D} at electrical terminal 124 of optical modulator 120 (FIG. 4) measured with respect to the ground potential.

Waveform 502 is an non-return-to-zero (NRZ) waveform in which binary zeros are represented by negative pulses of amplitude V₀ and binary ones are represented by positive pulses of amplitude V₀. Due to the above-explained clamping action, circuit 400 causes waveform 504 to be a positively shifted copy of waveform 502, with the offset voltage V_{C} and the upper and lower rails V_{U} and V_{L} being indicated in FIG. 5. The value of the offset voltage V_{C} is smaller than the amplitude V₀ due to the non-zero value of the intrinsic voltage drop Vₚₙ, which is also indicated in FIG. 5 (also see Eqs. (2)-(4)).

FIG. 6 shows a block diagram of an electro-optical circuit 600 according to an alternative embodiment. Similar to circuit 100 (FIG. 1), circuit 600 comprises optical modulator 120 electrically connected to the data driver using a clamping circuit. However, in circuit 600, optical modulator 120 is a part of two clamping circuits instead of just one as in circuit 100. One of these clamping circuits is a positive clamping circuit, and the other clamping circuit is a negative clamping circuit. In an example embodiment, electro-optical circuit 600 can be configured to drive optical modulator 120 in a differential configuration, e.g., as described below.

The two clamping circuits of circuit 600 are configured to share a load Z3 that is connected in parallel with an electrical-diode structure of optical modulator 120. The positive clamping circuit includes a capacitor C1 connected to electrical terminal 124 of optical modulator 120. The negative clamping circuit includes a capacitor C2 connected to electrical terminal 116 of optical modulator 120.

Circuit 600 further comprises a differential amplifier 610 having (i) a non-inverting output S connected by way of an output impedance Z1 to capacitor C1 and (ii) an inverting output S̅ connected by way of an output impedance Z2 to capacitor C2. Differential amplifier 610 operates as a data driver that generates varying output voltages V_{OUT} and −V_{OUT} at outputs S and S̅, respectively, in response to an input data signal 602.

In an example embodiment, the impedances Z1, Z2, and Z3 have the following relative values: Z₀, Z₀, and 2Z₀, respectively. The capacitances of capacitors C1 and C2 can be equal to one another. In this configuration, the drive voltages (e.g., as measured with respect to the ground potential) applied to electrical terminals 124 and 116 of optical modulator 120 are V_{D} and −V_{D}, respectively, where V_{D} can be approximated using Eq. (1). The corresponding offset voltages are V_{C} and −V_{C}, respectively, where V_{C} can be approximated using Eq. (2).

FIG. 7 shows a circuit diagram of an electro-optical circuit 700 that can be used to implement circuit 100 according to an embodiment. Similar to circuit 400, circuit 700 is designed and configured to have transmission lines that are impedance-matched to 50 ohm. As such, circuit 700 comprises (i) two instances (nominal copies) of waveform generator 410, which are labeled in FIG. 7 using the reference numerals 410₁ and 410₂, and (ii) two instances of termination circuit 430, which are labeled in FIG. 7 using the reference numerals 430₁ and 430₂.

Waveform generator 410₁ is directly driven by input data signal 602. Waveform generator 410₂ is similarly driven by a data signal 706 that is generated by an inverter 704 by inverting input data signal 602. In an example embodiment, inverter 704 can be implemented using a logic NOT-gate.

Termination circuit 430₁ is configured to terminate a transmission line 714₁ that connects waveform generator 410₁ and electrical terminal 124 of optical modulator 120. Termination circuit 430₂ is similarly configured to terminate a transmission line 714₂ that connects waveform generator 410₂ and electrical terminal 116 of optical modulator 120. Each of termination circuits 430₁ and 430₂ is further connected to a corresponding optional resistor R3 (also see FIG. 4), which are labeled in FIGS. 7 as R3₁ and R3₂, respectively.

According to an example embodiment disclosed above, e.g., in the summary section and/or in reference to any one or any combination of some or all of FIGS. 1-7, provided is an apparatus (e.g., 100, FIG. 1; 600, FIG. 6) comprising: an optical modulator (e.g., 120, FIGS. 1-4, 6, 7) comprising an optical waveguide (e.g., 210, FIG. 2B; 320, FIG. 3B) that includes at least a portion of a semiconductor diode (e.g., 212/214, FIG. 2B; 318/320/322, FIG. 3B), the semiconductor diode being electrically connected between first and second electrical terminals (e.g., 116, 124, FIGS. 1-4, 6, 7), the optical waveguide being optically coupled between an optical input (e.g., 118, FIGS. 1-4, 6, 7) and an optical output (e.g., 122, FIGS. 1-4, 6, 7) of the optical modulator; and a data driver (e.g., 110, FIG. 1; 410, FIGS. 4, 7; 610, FIG. 6) connected to the first and second electrical terminals to electrically drive the optical modulator in a manner that causes the optical modulator to modulate light traveling from the optical input to the optical output thereof in response to an input data signal (e.g., 102, FIGS. 1, 4; 602, FIGS. 6-7) received by the data driver; and wherein the data driver is electrically connected to the first and second electrical terminals in a manner that causes a first varying electrical signal (e.g., at 114, FIGS. 1, 4; at S, FIG. 6; at 714, FIG. 7) generated by the data driver in response to the input data signal to set a first DC-offset level (e.g., the quasi-DC component of V_{C}, Eqs. (1)-(2), FIG. 5) at one of the first and second electrical terminals of the semiconductor diode, the first DC-offset level being such as to cause the semiconductor diode to be reverse-biased.

In some embodiments of the above apparatus, the apparatus further comprises: a capacitor (e.g., C, FIG. 1) connected between an output terminal (e.g., 114, FIGS. 1, 4; 714, FIG. 7) of the data driver and the one of the first and second electrical terminals, the output terminal being configured to carry the first varying electrical signal; and a resistor (e.g., R, FIG. 1) connected to at least one of the first and second electrical terminals.

In some embodiments of any of the above apparatus, the apparatus further comprises an electrical clamping circuit that includes the semiconductor diode, the capacitor, and the resistor.

In some embodiments of any of the above apparatus, the first varying electrical signal is a bipolar signal (e.g., 502, FIG. 5) that has an amplitude; and the first DC-offset level depends on the amplitude (e.g., approximately in accordance with Eq. (2)).

In some embodiments of any of the above apparatus, the optical modulator is configured to modulate an intensity of the light traveling from the optical input to the optical output thereof in response to the input data signal received by the data driver.

In some embodiments of any of the above apparatus, the optical modulator is configured to modulate a phase of the light traveling from the optical input to the optical output thereof in response to the input data signal received by the data driver.

In some embodiments of any of the above apparatus, the optical modulator comprises an optical phase shifter (e.g., BB, FIG. 2B) that includes at least a portion of the optical waveguide.

In some embodiments of any of the above apparatus, the optical modulator comprises a ring waveguide (e.g., 210, FIG. 2A) optically coupled to a linear waveguide (e.g., 220, FIG. 2A); the ring waveguide comprises the optical waveguide (e.g., as indicated in FIG. 2A); and the optical input and the optical output are connected to opposite ends of the linear waveguide.

In some embodiments of any of the above apparatus, the optical modulator comprises an electro-absorption modulator (e.g., BB, FIG. 3B) that includes at least a portion of the optical waveguide.

In some embodiments of any of the above apparatus, the optical waveguide comprises a first portion (e.g., 212, FIG. 2B) and a second portion (e.g., 214, FIG. 2B), the first portion comprising an n-type semiconductor material, the second portion comprising a p-type semiconductor material.

In some embodiments of any of the above apparatus, the first portion and the second portion are attached to one another to form a PN junction, the PN junction being located within an optical core the optical waveguide (e.g., as indicated in FIG. 2B).

In some embodiments of any of the above apparatus, the semiconductor diode is a PIN diode comprising a p-type semiconductor material (e.g., 322, FIG. 3B), an n-type semiconductor material (e.g., 318, FIG. 3B), and an intrinsically doped semiconductor material (e.g., 320, FIG. 3B); and the optical waveguide comprises at least a portion of the intrinsically doped semiconductor material (e.g., as indicated in FIG. 3B).

In some embodiments of any of the above apparatus, the data driver is connected to the first and second electrical terminals in a manner that causes a second varying electrical signal (e.g., at S̅, FIG. 6; at 714₂, FIG. 7) generated by the data driver in response to the input data signal to set a second DC-offset level (e.g., the quasi-DC component of −V_{C}, Eq. (2), FIG. 6) at another one of the first and second electrical terminals of the semiconductor diode, the first and second DC-offset levels being such as to cause the semiconductor diode to be reverse-biased.

In some embodiments of any of the above apparatus, the data driver comprises an inverter (e.g., 704, FIG. 7) configured to generate an inverted data signal (e.g., 706, FIG. 7) by inverting the input data signal; and wherein the data driver is configured to generate the second varying electrical signal in response to the inverted data signal (e.g., as indicated in FIG. 7).

In some embodiments of any of the above apparatus, the first varying electrical signal is a bipolar signal that has a first amplitude; wherein the first DC-offset level depends on the first amplitude; wherein the second varying electrical signal is a bipolar signal that has a second amplitude; and wherein the second DC-offset level depends on the second amplitude.

In some embodiments of any of the above apparatus, the data driver is configured to drive the optical modulator in a differential manner using the first and second varying electrical signals.

In some embodiments of any of the above apparatus, the first and second DC-offset levels have opposite polarities.

In some embodiments of any of the above apparatus, the data driver comprises an electrical amplifier (e.g., 610, FIG. 6) having an inverting output (e.g., S̅, FIG. 6) and a non-inverting output (e.g., S, FIG. 6) and is configured to generate the first varying electrical signal and the second varying electrical signal at the non-inverting and inverting outputs, respectively, in response to the input data signal (e.g., 602, FIG. 6).

In some embodiments of any of the above apparatus, the apparatus further comprises: a first capacitor (e.g., C1, FIG. 6) connected between the non-inverting output of the amplifier and the first electrical terminal; and a second capacitor (e.g., C2, FIG. 6) connected between the inverting output of the amplifier and the second electrical terminal; and a resistor (e.g., Z3, FIG. 6) connected between the first and second electrical terminals in parallel with the semiconductor diode.

In some embodiments of any of the above apparatus, the apparatus does not have a bias tee that electrically connects the one of the first and second electrical terminals to an external DC-voltage source.

In some embodiments of any of the above apparatus, the apparatus further comprises a laser connected to apply light to the optical input of the optical modulator (e.g., as indicated in FIG. 1).

In some embodiments of any of the above apparatus, the semiconductor diode is configured to generate a photocurrent in response to the light traveling from the optical input to the optical output of the optical modulator.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain the nature of this disclosure may be made by those skilled in the art without departing from the scope of the disclosure, e.g., as expressed in the following claims.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Throughout the detailed description, the drawings, which are not to scale, are illustrative only and are used in order to explain, rather than limit the disclosure. The use of terms such as height, length, width, top, bottom, is strictly to facilitate the description of the embodiments and is not intended to limit the embodiments to a specific orientation. For example, height does not imply only a vertical rise limitation, but is used to identify one of the three dimensions of a three dimensional structure as shown in the figures. Such “height” would be vertical where the electrodes and layers are horizontal but would be horizontal where the electrodes and layers are vertical, and so on. Similarly, while all figures show the different layers as horizontal layers such orientation is for descriptive purpose only and not to be construed as a limitation.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The description and drawings merely illustrate the principles of the disclosure. It will thus be appreciated that those of ordinary skill in the art will be able to devise various arrangements that, although not explicitly described or shown herein, embody the principles of the disclosure and are included within its spirit and scope. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof.

What is claimed is:

1. An apparatus comprising:
an optical modulator comprising an optical waveguide that includes at least a portion of a semiconductor diode, the semiconductor diode being electrically connected between first and second electrical terminals, the optical waveguide being optically coupled between an optical input and an optical output of the optical modulator; and
a data driver connected to the first and second electrical terminals to electrically drive the optical modulator in a manner that causes the optical modulator to modulate light traveling from the optical input to the optical output thereof in response to an input data signal received by the data driver; and
wherein the data driver is electrically connected to the first and second electrical terminals in a manner that causes a first varying electrical signal generated by the data driver in response to the input data signal to set a first DC-offset level at one of the first and second electrical terminals of the semiconductor diode, the first DC-offset level being such as to cause the semiconductor diode to be reverse-biased.

2. The apparatus of claim 1, further comprising:
a capacitor connected between an output terminal of the data driver and the one of the first and second electrical terminals, the output terminal being configured to carry the first varying electrical signal; and
a resistor connected to at least one of the first and second electrical terminals.

3. The apparatus of claim 2, further comprising an electrical clamping circuit that includes the semiconductor diode, the capacitor, and the resistor.

4. The apparatus of claim 1,
wherein the first varying electrical signal is a bipolar signal that has an amplitude; and
wherein the first DC-offset level depends on the amplitude.

5. The apparatus of claim 1, wherein the optical modulator is configured to modulate an intensity of the light traveling from the optical input to the optical output thereof in response to the input data signal received by the data driver.

6. The apparatus of claim 1, wherein the optical modulator is configured to modulate a phase of the light traveling from the optical input to the optical output thereof in response to the input data signal received by the data driver.

7. The apparatus of claim 1, wherein the optical modulator comprises an optical phase shifter that includes at least a portion of the optical waveguide.

8. The apparatus of claim 7,
wherein the optical modulator comprises a ring waveguide optically coupled to a linear waveguide;
wherein the ring waveguide comprises the optical waveguide; and
wherein the optical input and the optical output are connected to opposite ends of the linear waveguide.

9. The apparatus of claim 1, wherein the optical modulator comprises an electro-absorption modulator that includes at least a portion of the optical waveguide.

10. The apparatus of claim 1,
wherein the optical waveguide comprises a first portion and a second portion, the first portion comprising an n-type semiconductor material, the second portion comprising a p-type semiconductor material; and
wherein the first portion and the second portion are attached to one another to form a PN junction, the PN junction being located within an optical core the optical waveguide.

11. The apparatus of claim 1,
wherein the semiconductor diode is a PIN diode comprising a p-type semiconductor material, an n-type semiconductor material, and an intrinsically doped semiconductor material; and
wherein the optical waveguide comprises at least a portion of the intrinsically doped semiconductor material.

12. The apparatus of claim 1, wherein the data driver is connected to the first and second electrical terminals in a manner that causes a second varying electrical signal generated by the data driver in response to the input data signal to set a second DC-offset level at another one of the first and second electrical terminals of the semiconductor diode, the first and second DC-offset levels being such as to cause the semiconductor diode to be reverse-biased.

13. The apparatus of claim 12,
wherein the data driver comprises an inverter configured to generate an inverted data signal by inverting the input data signal; and
wherein the data driver is configured to generate the second varying electrical signal in response to the inverted data signal.

14. The apparatus of claim 12,
wherein the first varying electrical signal is a bipolar signal that has a first amplitude;
wherein the first DC-offset level depends on the first amplitude;
wherein the second varying electrical signal is a bipolar signal that has a second amplitude; and
wherein the second DC-offset level depends on the second amplitude.

15. The apparatus of claim 12, wherein the data driver is configured to drive the optical modulator in a differential manner using the first and second varying electrical signals.

16. The apparatus of claim 12, wherein the first and second DC-offset levels have opposite polarities.

17. The apparatus of claim 12, wherein the data driver comprises an electrical amplifier having an inverting output and a non-inverting output and is configured to generate the first varying electrical signal and the second varying electrical signal at the non-inverting and inverting outputs, respectively, in response to the input data signal.

18. The apparatus of claim 17, further comprising:
a first capacitor connected between the non-inverting output of the amplifier and the first electrical terminal; and
a second capacitor connected between the inverting output of the amplifier and the second electrical terminal; and
a resistor connected between the first and second electrical terminals in parallel with the semiconductor diode.

19. The apparatus of claim 1, wherein the apparatus does not have a bias tee that electrically connects the one of the first and second electrical terminals to an external DC-voltage source.

20. The apparatus of claim 1, wherein the semiconductor diode is configured to generate a photocurrent in response to the light traveling from the optical input to the optical output of the optical modulator.
